(19) United States
(12) Patent Application Publication
(10) Pub. No.: US 2025/0334221 A1
(43) Pub. Date: Oct. 30, 2025

(54) STAND HAVING FAST REPLACEABLE BASE

(71) Applicant: OXTI Pte Ltd, Singapore (SG)

(72) Inventor: Chih-Feng Ho, Singapore (SG)

(21) Appl. No.: 18/644,139

(22) Filed: Apr. 24, 2024

(51) Int. Cl. F16M 11/16

(52) U.S. Cl. CPC F16M 11/16; F16M 2200/08

(57) ABSTRACT

A stand having a fast replaceable base includes a base, which includes a support frame for receiving an electronic device to mount thereto and has at least two connected portions; and at least two bracing portions, which are mountable to and removable from the base, the bracing portions each including a first end and a second end, the first ends of the bracing portions being each formed with a connecting portion, the connecting portions being connectable with and complementary to the connected portions. The bracing portions are made detachable and re-mountable, so that in case that the electronic device is replaced with one having a different size, it only needs to replace the bracing portions with ones having different lengths, and as such, for fabrication, there is no need to manufacture bases of different sizes to suit the needs for various sizes of the display.

### BACKGROUND OF THE INVENTION

### (a) Technical Field of the Invention

The present invention relates to a base, and more particularly to a base that is fast replaceable according to size variation of an electronic device supported thereby.

### (b) Description of the Prior Art

As shown in FIG. 1, a base 100 of a known display support frame is provided with two extended portions 101 to prevent the display 200 from toppling down. The two extended portions 101 are connected to the base 100 and are not detached therefrom. The base 100 is designed to meet safety regulations for tip tests (such as 10-degree platform test) in both downward and upward tilting. Consequently, as the size of the display is increased, the length of the extended portions 101 must be varied in order to meet the safety regulations. This makes it necessary to change the base 100 if the display 200 is replaced with one having a different size, and fabricating various sizes of the base 100 is necessary to suit the need for different sizes of the display 200, and in addition, an enlarged space would be necessary for packaging.

Taiwan Utility Model M629582 discloses a display stand, and as shown in FIG. 7 of the Utility Model, a clamp set is provided to allow a stand to be clamped at a fixing end (such as a desk) to prevent the stand from toppling down. Such an arrangement makes it necessary for the stand to be installed at a location where a fixing end exists. This limits the location of installation. For example, such a device is not applicable to a desk adjacent to a wall or a floor.

### SUMMARY OF THE INVENTION

In view of the above problems, an objective of the present invention is to provide a stand having a fast replaceable base.

To achieve the above-mentioned objective, the present invention provides a fast-base-replaceable stand, which comprises:
a base, wherein the base comprises a support frame, and the base is formed with at least two connected portions, the support frame receiving an electronic device to mount thereto; and
at least two bracing portions, wherein the bracing portions are mountable to and removable from the base, and the bracing portions are each provided with a first end and a second end, the first ends of the bracing portions being each formed with a connecting portion, the connecting portions being connectable with and complementary to the connected portions.

Based on the connected portions of the base and the connecting portions of the bracing portions, the bracing portions are made detachable and re-mountable, so that in case that the electronic device is replaced with one having a different size, it only needs to replace the bracing portions with ones having different lengths, and as such, for fabrication, there is no need to manufacture bases of different sizes to suit the needs for various sizes of the display and for packaging, space saving can be achieved.

### BRIEF DESCRIPTION OF THE DRAWINGS

FIG. 1 is a schematic view of prior art.

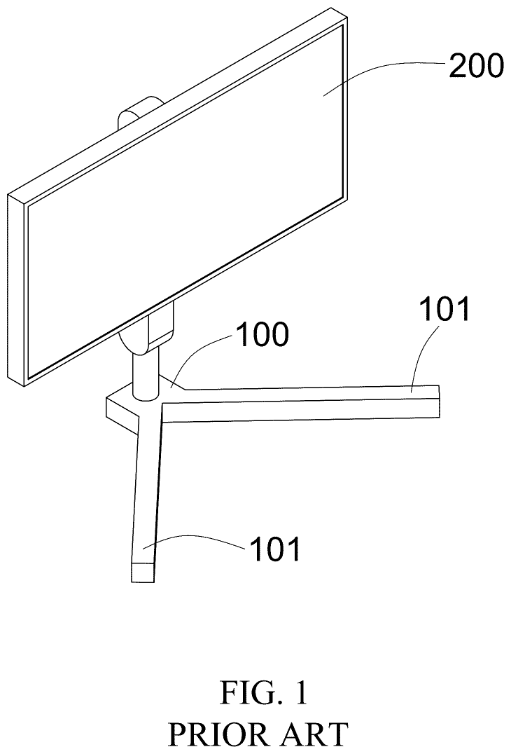

FIG. 2 is an assembled view of the present invention.

FIG. 3 is an exploded view of the present invention.

FIG. 4 is a schematic view illustrating replacement of different bracing portions according to the present invention.

### DETAILED DESCRIPTION OF THE PREFERRED EMBODIMENTS

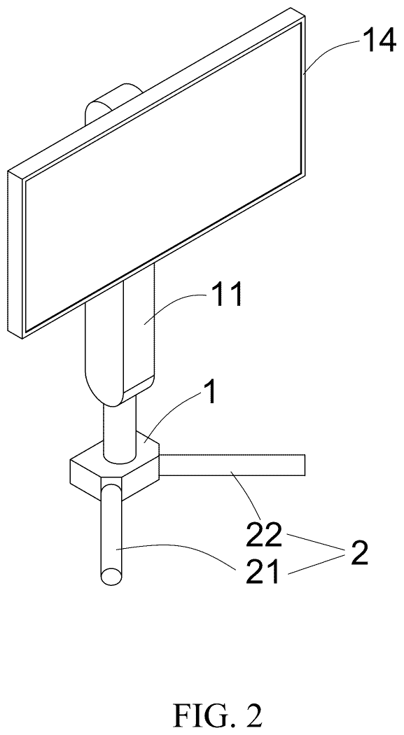

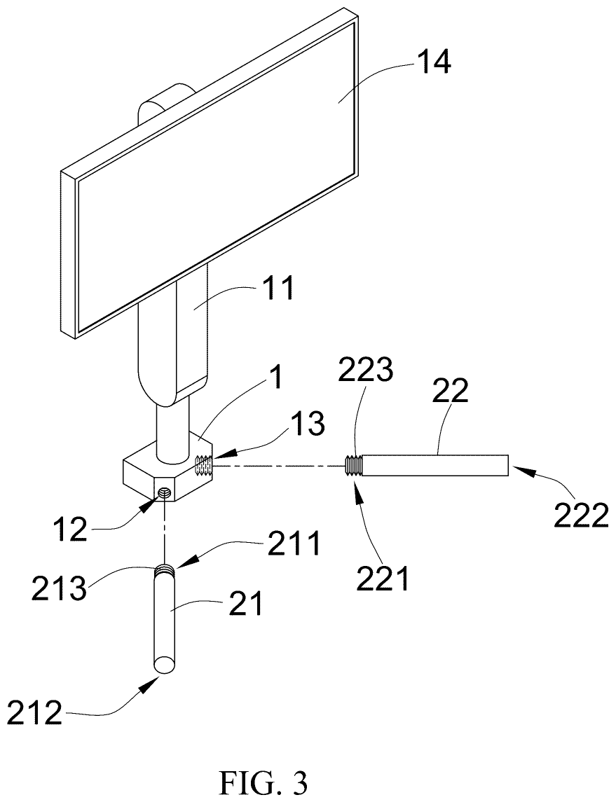

Referring to FIGS. 2 and 3, a fast-base-replaceable stand comprises:
a base 1, wherein the base 1 comprises a support frame 11, and the base 1 is formed with at least two connected portions, which, in an example of the instant embodiment, include a first connected portion 12 and a second connected portion 13, and wherein the support frame 11 receives an electronic device 14 to mount thereto; and
at least two bracing portions 2, wherein the bracing portions 2 are mountable to and removable from the base 1, and the bracing portions are each provided with a first end and a second end, wherein the first ends of the bracing portions 2 are each provided with a connecting portion, the connecting portions being connectable with and complementary to the connected portions, and include, in an example of the instant embodiment, a first bracing portion 21 and a second bracing portion 22, wherein the first bracing portion 21 is provided with a first end 211 and a second end 212, the first end 211 of the first bracing portion 21 being formed with a first connecting portion 213; and the second bracing portion 22 is provided with a first end 221 and a second end 222, the first end 221 of the second bracing portion 22 being formed with a second connecting portion 223, the first connecting portion 213 being connectable with and complementary to the first connected portion 12, the second connecting portion 223 being connectable with and complementary to the second connected portion 13.

The first connecting portion 213 and the second connecting portion 223 are each a protruding portion.

The first connecting portion 213 and the second connecting portion 223 are each formed with an external thread.

The first connected portion 12 and the second connected portion 13 are each a recessed portion.

The first connected portion 12 and the second connected portion 13 are each formed with an internal thread.

The electronic device 14 comprises a screen.

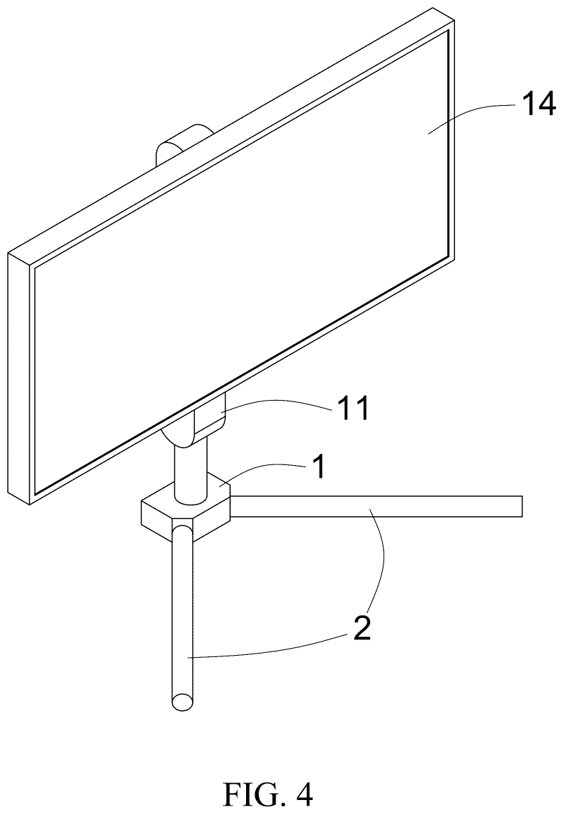

When a user replaces the electronic device 14 with one having a different size, with the present invention, the first connecting portion 213 and the second connecting portion 223 of the first bracing portion 21 and the second bracing portion 22 are detachable from the first connected portion 12 and the second connected portion 13 of the base 1, so that for the replacement of the electronic device 14 with one having a larger size, the user only needs to replaceably mount bracing portions 2 having extended lengths to the base 1 to make the entirety more secured, as shown in FIG. 4, so as to meet the safety regulation of tip tests for 10-degree platform test, without the need to replace the entire base 1 thereby preventing unnecessary waste of resources.

Based on the first connected portion 12 and the second connected portion 13 of the base 1 and the first connecting portion 213 and the second connecting portion 223 of the first bracing portion 21 and the second bracing portion 22, the bracing portions 2 are made removable and re-mountable, so that in case that the electronic device 14 is replaced with one having a different size, it only needs to replace the bracing portions 2 with ones having different lengths, and for fabrication, there is no need to manufacture bases 1 of different sizes to suit the needs for various sizes of the electronic device 14, and for packaging, packaging can be made with the bracing portions 2 removed from the base 1 to achieve an effect of space saving, and the present invention requires no clamp set for clamping at a fixing end for mounting, and it only needs to place the present invention on a horizontal surface, so as there is no limit to position for the present invention as compared with the prior art.

I claim:

1. A fast-base-replaceable stand, comprising:
a base, wherein the base comprises a support frame, and the base is formed with at least two connected portions; and
at least two bracing portions, wherein the bracing portions are mountable to and removable from the base, and the bracing portions are each provided with a first end and a second end, the first ends of the bracing portions being each formed with a connecting portion, the connecting portions being connectable with and complementary to the connected portions.

2. The fast-base-replaceable stand according to claim 1, wherein the support frame is provided with an electronic device.

3. The fast-base-replaceable stand according to claim 2, wherein the electronic device comprises a screen.

4. The fast-base-replaceable stand according to claim 1, wherein the connecting portions are each a protruding portion.

5. The fast-base-replaceable stand according to claim 1, wherein the connecting portions are each formed with an external thread.

6. The fast-base-replaceable stand according to claim 1, wherein the connected portions are each a recessed portion.

7. The fast-base-replaceable stand according to claim 1, wherein the connected portions are each formed with an internal thread.
